(19) United States
(12) Patent Application Publication
(10) Pub. No.: US 2025/0053787 A1
(43) Pub. Date: Feb. 13, 2025

(54) SYSTEMS AND METHODS FOR PERSONALIZED MULTI-TASK TRAINING FOR RECOMMENDER SYSTEMS

(71) Applicant: Salesforce, Inc., San Francisco, CA (US)

(72) Inventors: Liangwei Yang, Palo Alto, CA (US); Shelby Heinecke, San Francisco, CA (US); Jianguo Zhang, San Jose, CA (US); Rithesh Murthy, San Francisco, CA (US); Huan Wang, Palo Alto, CA (US); Caiming Xiong, Menlo Park, CA (US); Zhiwei Liu, Palo Alto, CA (US)

(21) Appl. No.: 18/429,119

(22) Filed: Jan. 31, 2024

Related U.S. Application Data
(60) Provisional application No. 63/518,827, filed on Aug. 10, 2023.

(51) Int. Cl. G06N 3/0455; G06N 3/084; G06Q 30/0601

(52) U.S. Cl. CPC G06N 3/0455; G06N 3/084; G06Q 30/0631

(57) ABSTRACT

Embodiments described herein provide a method for training a recommendation neural network model using multiple data sources. The method may include: receiving, via a data interface, time series data indicating a user-item interaction history; transforming the time series data into a user-item graph; encoding, by a neural network encoder, the user-item graph into user embeddings and item embeddings; generating a plurality of losses according to a plurality of training tasks performed based on the user embeddings and, item embeddings; training the recommendation neural network model by updating the user embeddings and the item embeddings via backpropagation based on a weighted sum of gradients of the plurality of losses; and generating, by a neural network decoder, one or more recommended items for a given user based on the updated user embeddings and the updated item embeddings.

### CROSS REFERENCE(S)

The instant application is a nonprovisional of and claim priority under 35 U.S.C. 119 to U.S. provisional application No. 63/518,827, filed Aug. 10, 2023, which is hereby expressly incorporated by reference herein in its entirety.

### TECHNICAL FIELD

The embodiments relate generally to machine learning systems for generating recommendations, and more specifically to personalized multi-task training for recommender systems.

### BACKGROUND

Machine learning systems may be used to recommend products for a user such that the user does not need to navigate through an immerse collection of options. For example, a recommender system may generate a movie recommendation from a user based on their viewing history and potentially viewing histories of other users. However, existing recommendation system at most harvest user activity data such as the user/item interaction (e.g., viewing history, clicks, likes, etc.) from a single domain to build a preference profile for the user. Recommendations made using such single-domain preference data often fail to depict user preference or intention.

### BRIEF DESCRIPTION OF THE DRAWINGS

FIG. 1 is a simplified diagram illustrating a multi-task recommendation, according to some embodiments.

FIG. 2 is a simplified diagram illustrating a personalized multi-task training framework, according to some embodiments.

FIG. 3A is a simplified diagram illustrating a computing device implementing the personalized multi-task training framework described in FIGS. 2 and 5A, according to some embodiments.

FIG. 3B is a simplified diagram illustrating a neural network structure, according to some embodiments.

FIG. 4 is a simplified block diagram of a networked system suitable for implementing the personalized multi-task training framework described in FIGS. 2 and 5A and other embodiments described herein.

FIG. 5A is an example pseudo-code segment illustrating an example algorithm for a method of training based on the framework shown in FIG. 2, according to some embodiments.

FIG. 5B is an example logic flow diagram illustrating a method of personalize multi-task training based on the framework shown in FIGS. 2 and 5A, according to some embodiments.

FIGS. 6-11 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

### Overview

Recommender systems make recommendations to users based on their preferences. For example, a user may be recommended with movies that are similar to what he has previously watched. Such personalized recommendation is traditionally generated using embeddings of user/item (e.g., movie) interactions. However, merely using the user/item interaction on a single website (e.g., a single source) may not often provide a full picture of user preference to generate accurate recommendations.

In view of the need for more accurate recommendations, embodiments described herein provide a framework that generates a comprehensive user/item embedding using multiple sources of information which may be applied to multiple types of tasks. In some aspects, the embedding framework includes an encoder that encodes a history of user-item interactions taking a form of a user-item graph into user embeddings and item embeddings. These embeddings may be applied to generate various different types of tasks outputs, such as item recommendation, social similarity recommendation, and/or the like. The different tasks outputs may be used to compute different losses for different tasks, which are in turn use to compute a collection of gradients. A combined weighted sum of the gradients are then used to update the embeddings via an optimizer.

In this way, user activities from multiple domains or sources can be aggregated to make different types of recommendations with enhanced accuracy. Such multi-source based recommendation systems may be widely applies to artificial intelligence applications (AI) such as an AI shopping agent application, an intelligent content streaming application, and/or the like. AI service agent technology is thus improved.

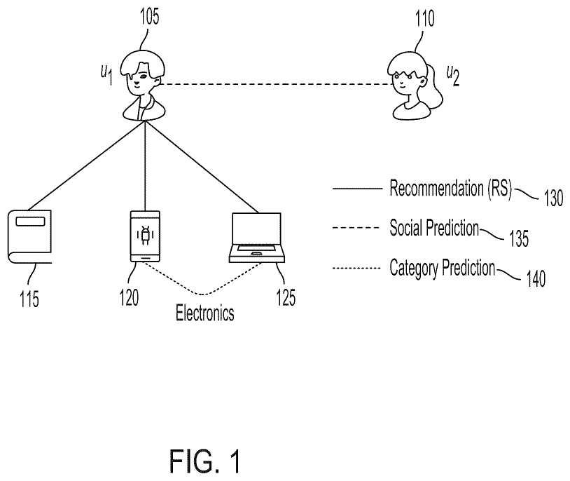

FIG. 1 is a simplified diagram illustrating example use cases of a multi-task recommendation system, according to embodiments described herein. FIG. 1 shows the interactions between a first user, u₁, 105, second user, u₂, 110, a book recommendation 115, a phone recommendation 120, and a laptop recommendation 125 that formulate different recommendation tasks. For example, an item recommendation task might include providing the first user 105 with the best recommendation 130 for items based on the first user's preferences, e.g., book 115, phone 120, and/or laptop 125. A social recommendation task might include recommending to the first user 105 the second user 110 as a recommended social contact who might share mutual interests and/or online activities with the first user. A category recommendation task might include recommending to the first user 105 one or more items that belong to a particular category, e.g., an electronics prediction 140 for the phone 120 and laptop 125.

In one embodiment, the multi-task recommendation system may be trained to generate user/item embeddings on a plurality of different recommendation tasks such as but not limited to tasks 130, 135 and 140 shown in FIG. 1, incorporating information from multiple sources, leading to a more comprehensive representation of the embeddings.

For example, the task of recommendation may be formulated using interactions between users and items, formalized as edges in a graph, described further as follows. Given a set of users [symbol] ={u₁, u₂, . . . , [symbol] } and a set of items [symbol] ={i₁, i₂, . . . , [symbol] }, the personalized RS task aims to generate a list of items for a given user u. The most important information for training a recommendation model is the currently observed historical interactions, which can be represented as a user-item bipartite graph [symbol] =( [symbol] ), where [symbol] = [symbol] and there is an edge (u, i) ∈ε between u and i if u has interacted with i historically. The adjacency matrix of [symbol] is represented by R [symbol] [symbol] . For implicit feedback such as clicks, views, and purchases, R_{u,i}=1 if user u has interacted with item i, and R_{u,i}=0 otherwise. For explicit feedback, the user provides, such as rating score, R_{u,i} is the explicit rating score from u to i. Besides the direct historical interactions, auxiliary information can also be observed from both the user and item side, which is termed by profile [symbol] =( [symbol] ^{u}, [symbol] ⁱ)· [symbol] ^{u} contains all the auxiliary information from the user side, such as features and social friends. [symbol] ⁱ represents the item side auxiliary information such as category and co-view information. Based on all the above information, personalized RS aims to predict the preference score in the adjacency matrix of [symbol] and recommends a list of k items with the top-k highest score.

In some embodiments, multi-task learning is employed to train recommender systems. Multi-task learning (MTL) aims to learn a comprehensive model to accomplish multiple tasks by training them simultaneously. This learning paradigm assumes different tasks can enhance each other and perform better on all tasks. Each task is trained and can be categorized by a loss function [symbol] , which directly leads to a gradient ∇ [symbol] after backpropagation. Assuming we have T tasks, then a list of the gradient for different tasks is obtained (∇ [symbol] ₁∇ [symbol] ₂, . . . , ∇ [symbol] _{T}). An MTL procedure can be seen as a pooling function over the gradient list to obtain the combined gradient for descent ∇=Pool_{MTL}(∇ [symbol] ₁∇ [symbol] ₂, . . . , ∇ [symbol] _{T}). Different MTL procedures differ in the design of the pooling function, which can be parameterized or heuristic.

In some embodiments, it is to be noted that the three recommendation tasks 130, 135 and 140 are for illustrative purpose only. Fewer or greater number of tasks may be used in multi-task learning for recommender systems. For example, in some instances, social link prediction task and associated information may be used along with a recommendation task. In another example, a recommendation task and 3, 4, 5, or more tasks may guide the training.

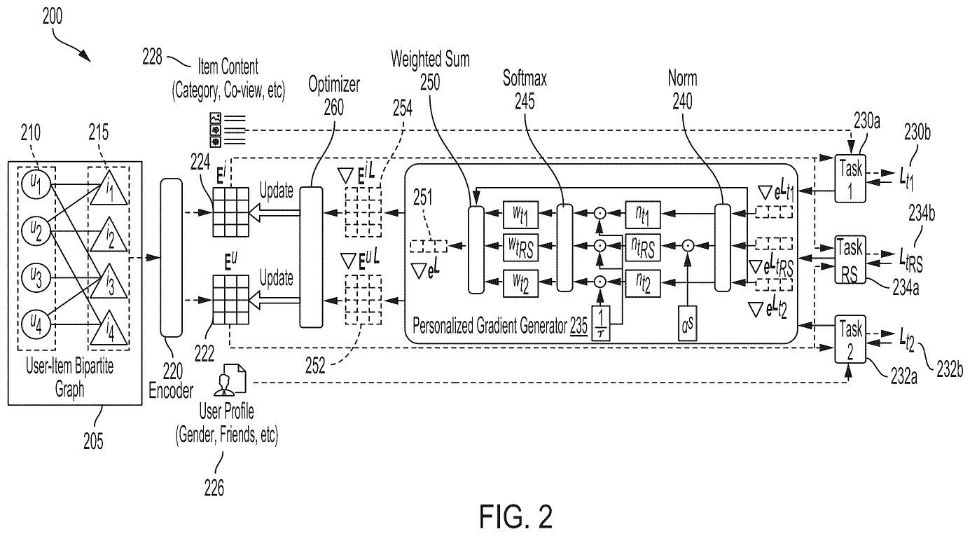

FIG. 2 is a simplified diagram illustrating a personalized multi-task training framework 200, according to some embodiments. The framework 200 comprises an encoder 220, a gradient generator 235, and an optimizer 260 that jointly operate to train a multi-task recommendation system to perform different types of recommendation tasks for a user as shown in FIG. 1.

In one embodiment, framework 200 includes a forward propagation stage to gather gradients from multiple tasks and a backward stage to aggregate gradients from different tasks individually. Framework 200 trains an encoder 220 based on known, historical interactions of one or more users 210 with one or more items 215. The historical interactions of users and items, including a time series of historical interaction, may be represented as a user-item bipartite graph 205, denoted by [symbol] . The user-item bipartite graph 205 shows a plurality of edges connecting a user and an item if the user has previously interacted with the item (e.g., browsing, liking, purchasing, and/or the like). In some embodiments, graph 205 may have other structures, including non-bipartite.

As shown in FIG. 2, the user-item bipartite graph 205 may be fed to and encoded by an encoder 220, such as a graph encoder. Encoder 220 may thus embed historical interactions represented as user-item bipartite graph 205 into dense embedding representations E:

$$E = Encoder ( ) \qquad ( 1 )$$

where E=(E^{u}, Eⁱ), and E^{u} ∈ [symbol] and Eⁱ ∈ [symbol] represent the user embedding table 222 and item embedding table 224 separately, where d is the dimension size. User u's embedding, eᵤ∈E^{u}, has dimension d and encodes the specific information related to u's historical interactions. The user's embedding is the bedrock to provide personalized recommendations for u.

All or a portion of user embedding 222 and/or item embedding 224, along with user profiles 226 and item content 228, are passed to task modules 230a, 232a, 234a. For example, user profiles 226 may include information about a user, such as age, gender, friends, etc., and item content may include category information, a list of items frequently viewed with a particular item.

Each task module 230a, 232a, 234a may produce a different type of recommendation task output, e.g., one of 130, 135 or 140 in FIG. 1, based on the user embeddings 222 and item embeddings 224 (and optionally user profiles 226 and item content 228). For example, the training tasks [symbol] are classified into the main recommendation task t_{RS} and auxiliary tasks [symbol] _{AUX}=(t₁, 1₂, . . . , [symbol] ). Auxiliary tasks can be built in different ways based on the available information. As shown in FIG. 2, Task 1 230a is built purely from item embedding table Eⁱ 224 and item profile [symbol] ⁱ. It aims to embed the item's profile information to the corresponding item embedding. For example, Task 1 may be an item categorization task. Task 2 is built in a similar way from the user side. For example, Task 2 may be a social prediction task, predicting users who may have shared interests or connections with a particular user. Tasks can be designed based on the available information for each dataset.

Losses 230b, 232b, 234b may be computed based on the corresponding tasks outputs from task modules 230a, 232a, 234a, respectively. For example, losses 230b, 232b, 234b may be computed as a cross-entropy between the recommended tasks outputs and a ground truth label in the training data. The losses 230b, 232b, 234b may adopt the same or different types of loss functions. The collection of losses may be written as:

$$( {ℒ}_{RS} , {ℒ}_{1} , {ℒ}_{2} , … , ) \qquad ( 2 )$$

While FIG. 2 depicts three tasks, the main recommendation task 234a, Task 1, 230a, and Task 2 232a, any number of tasks may be used in conjunction with the recommendation task 234a. The number of task and the type of tasks may be limited by the available data. For instance, if user profile information is not available, then Task 2 232a may not be feasible to implement. Alternatively, if large amount of user profile data is available, then multiple tasks may be fashioned based on the user profile information.

After losses 230b, 232b, and 234b have been computed, gradients of the losses may be computed to update the embedding tables 222, 224 through backpropagation. For example, gradient generator 235 computes gradients of the losses from Eq. (2): for each user/item, each loss [symbol] in Equation (2) leads to one gradient on the embedding vector, e, corresponding to the user/item. The gradient is denoted as ∇ₑ [symbol] . The collection of gradients from different tasks on the specific user/item is represented by:

$$( {∇}_{e} {ℒ}_{RS} , {∇}_{e} {ℒ}_{1} , {∇}_{e} {ℒ}_{2} , … , {∇}_{e} ) \qquad ( 3 )$$

In one embodiment, gradient generator 235 computes the norm 240 using the l₂ norm, Nₜ=|∇₂ [symbol] ₜ|₂ to measure the impactfulness of the gradient. A larger Nₜ indicates the current user/item is more impactful to optimize task t. Gradient generator 235 then generates a list of norms:

$$( {n}_{RS} , {n}_{1} , {n}_{2} , … , ) = ( \vert {∇}_{e} {ℒ}_{RS} \vert , \vert {∇}_{e} {ℒ}_{1} \vert , \vert {∇}_{e} {ℒ}_{2} \vert , … , \vert {∇}_{e} \vert ) \qquad ( 3 )$$

In some implementations, different weight may be applied to the norm corresponding to different recommendation task. For example, gradient generator 235 applies a task focusing scaling parameter on the main recommendation task. For personalized multi-task training, framework 200 treats the RS task (e.g., with task module 234a) as the main task and all the other tasks as auxiliary ones for further improvement. Auxiliary tasks are built differently, leading to varied task orientations and may even contradict the main task. Thus, Task Focusing is used to focus the training on the main RS task gradually. To this end, a hyper-parameter α>1 is introduced as the increasing base. The gradient norm on the main RS task is transformed in the following way:

$${n}_{RS} \to {n}_{RS} * {α}^{s} , \qquad ( 4 )$$

where s is the current epoch number. Thus, framework 200 will explore all tasks first and gradually focus the training on the main RS task as the epoch number increases. The training will be aligned with the main RS task at the final stage. A larger s will increase the focusing speed.

### Gradient Collection

As shown in FIG. 2, In one embodiment, the gradient generator 235 may further apply gradient magnitude balancing to the generated norm vector that focuses on the main recommendation task. For example, a softmax layer 245 may be used to further generate gradient weights. The loss functions within Equation (2) are different due to the varied task designs, making the gradient magnitude essentially different (sometimes more than 10 times). The gradient with a small magnitude will be overlooked if the gradient norm is directly transformed into a gradient weight. Thus, gradient magnitude balancing is used to balance the impact of different gradient magnitudes. The gradient weight may be obtained by a Softmax with hyperparameter t, written in equation form as:

$${w}_{t} = \frac{exp ( {n}_{t} / τ )}{{\sum }_{t * ∈ 𝒯} exp ( {n}_{t *} / τ )} \qquad ( 5 )$$

For example, all task weights will be the same without being impacted by different gradient magnitudes when τ→∞. Conversely, only the gradient with the largest norm will be considered when τ→0. A suitable τ balance may be pre-defined, or empirically selected for the best gradient magnitude.

In one embodiment, gradient generator 235 can obtain the gradient weights from different tasks as (w_{RS}, w₁, w₂, . . . , [symbol] ), based on a weighted sum 250 to obtain the gradient on the corresponding user/item:

$${∇}_{e} ℒ = {w}_{t} {∇}_{e} {ℒ}_{𝓉} \qquad ( 6 )$$

where ∇ₑ is the combined gradient for a specific user/item, giving a personalized gradient 251 for the user/item. The personalized gradient 251 for various user and item embedding may be grouped into personalized user gradients 252 and personalized item gradients 254.

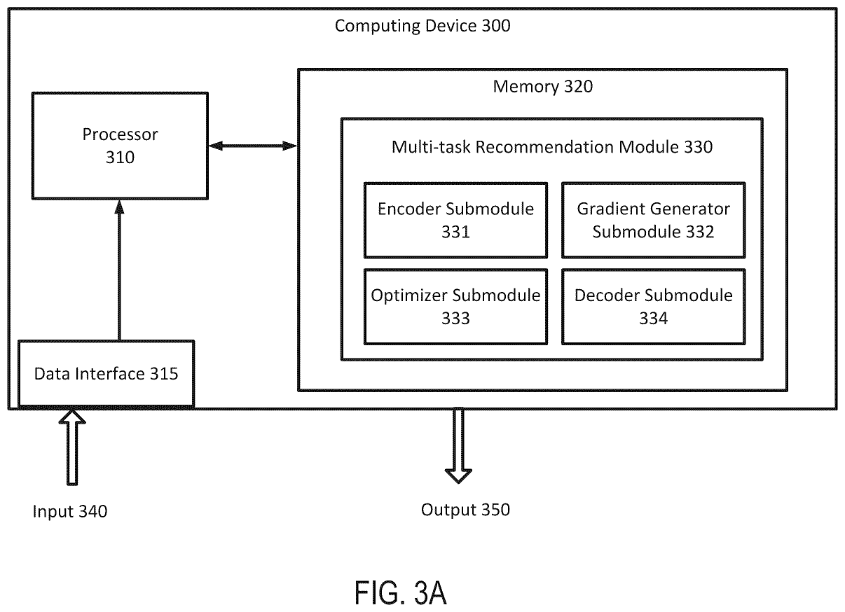

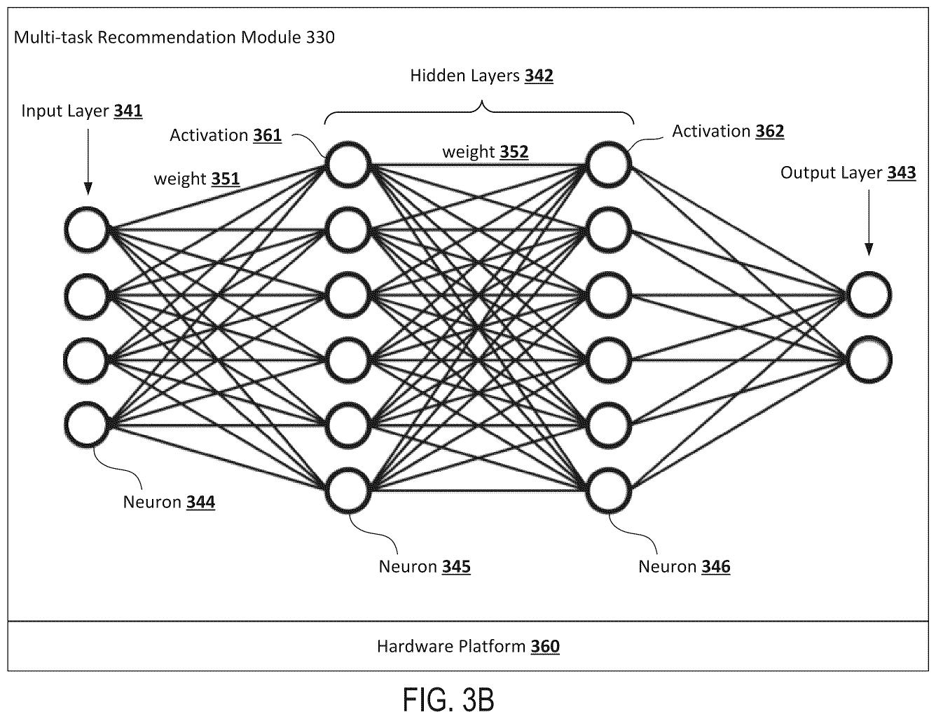

In one embodiment, the personalized user gradients 252 and personalized item gradients 254 may then be used to update the embedding tables 224 and 222, respectively, via backpropagation. Details of backpropagation using a gradient may be discussed in relation to FIG. 3B.

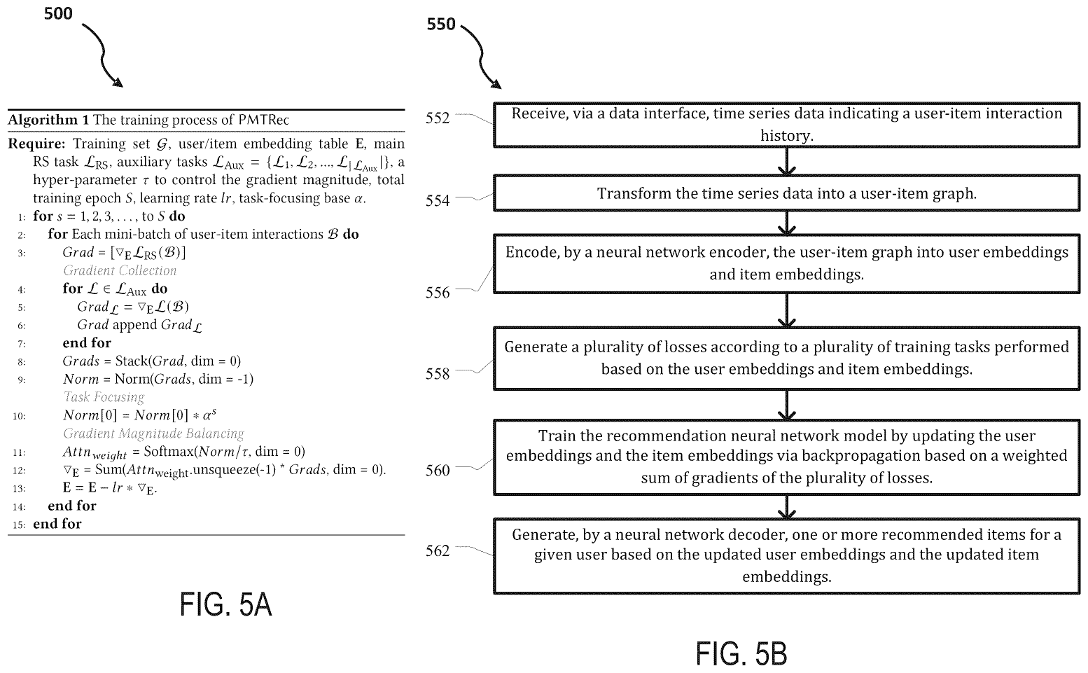

In some implementations, the personalized user gradient 252 and personalized item gradients 254, i.e., Eq. 6, are fed to an optimizer 260. Optimized 260 includes a set of rules that compute updates to the embedding tables 222 and 224 for the user/items. For example, the optimizer 260 may be an Adaptive Moment Estimation (Adam) optimizer. An example operation of training framework 200 is further shown in the pseudocode 500, depicted in FIG. 5A.

After application of the training framework 200, at inference, updated embedding tables 222, 224 may be used to generate user and/or item embeddings for a given user having a plurality of item interaction histories from different sources, based on which a particular recommendation task module can generate a corresponding recommendation for the given user based on the generated user and/or item embeddings. For example, in one implementation, the multi-task system may comprise all task modules 230a, 234a, 232a as different decoder heads, and a text prompt may be fed to the multi-task system to guide the system to generate a particular type of recommendation, e.g., when the text prompt describes “please recommend an influencer for me to follow” the multi-task system may generate a social recommendation for the user.

### Computer and Network Environment

FIG. 3A is a simplified diagram illustrating a computing device implementing the personalized multi-task training framework described in FIG. 2, according to one embodiment described herein. As shown in FIG. 3A, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for Multi-task recommendation module 330 that may be used to implement and/or emulate the systems and models, and/or to implement any of the methods described further herein. Multi-task recommendation module 330 may receive input 340 such as an input training data (e.g., historical interactions of users and items in the form of a user-item bipartite graph) via the data interface 315 and generate an output 350 which may be an updated embedding table and/or a recommendation.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as historical interactions of users and items, from a user via the user interface.

In some embodiments, the Multi-task recommendation module 330 is configured to update an embedding table and/or provide a recommendation. The Multi-task recommendation module 330 may further include Encoder submodule 331 (e.g., similar to 220 in FIG. 2). Encoder submodule 331 may be configured to encode user-item bipartite graphs into a dense embedding representation, including the historical user-item interactions. The Multi-task recommendation module 330 may further include Gradient Generator submodule 332 (e.g., similar to 235 in FIG. 2). Gradient Generator submodule 332 may be configured to generate a personalized multi-task gradient associated with a user/item embedding. The Multi-task recommendation module 330 may further include Optimizer submodule 333 (e.g., similar to 260 in FIG. 2). Optimizer submodule 333 may be configured to generate an update for the embedding table (e.g., 222, 224) from the personalized multi-task gradient. Multi-task recommendation module 330 may further include Decoder submodule 334 (e.g., similar to task modules 230a, 232a, 234a in FIG. 2) to generate a particular type of recommendation to a user based on embeddings from the encoder submodule 331.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 3B is a simplified diagram illustrating the neural network structure implementing the Multi-task recommendation module 330 described in FIG. 3A, according to some embodiments. In some embodiments, the Multi-task recommendation module 330 and/or one or more of its submodules 331-334 may be implemented at least partially via an artificial neural network structure shown in FIG. 3B. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as user-item bipartite graph. The number of nodes (neurons) in the input layer 341 may be determined by the dimensionality of the input data (e.g., the length of a vector of the representation of a user-item bipartite graph). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3A, the Multi-task recommendation module 330 receives an input 340 of user-item bipartite graph representing historical user-item interactions and transforms the input into an output 350 of an update to the embedding tables 222, 224. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class. In an encoding task, the dimension of the embedding space.

Therefore, the Multi-task recommendation module 330 and/or one or more of its submodules 331-334 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may be a sequence of embedding layers and fully connected layers, and/or the like.

In one embodiment, the Multi-task recommendation module 330 and its submodules 331-333 may be implemented by hardware, software and/or a combination thereof. For example, the Multi-task recommendation module 330 and its submodules 331-334 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

In one embodiment, the neural network based Multi-task recommendation module 330 and one or more of its submodules 331-334 may be trained by iteratively updating the underlying parameters (e.g., weights 351, 352, etc., bias parameters and/or coefficients in the activation functions 361, 362 associated with neurons) of the neural network based on the losses described in Eq. 2. For example, during forward propagation, the training data such as user-item bipartite graph are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding to known preferred recommendations) from the training data, to compute a loss function that measures the discrepancy between the predicted output and the expected output. For example, the loss function may be MMSE, cross-entropy loss, or any other loss function appropriate for the training task. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

Parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating recommendations for a new user not in the training data.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in recommender systems.

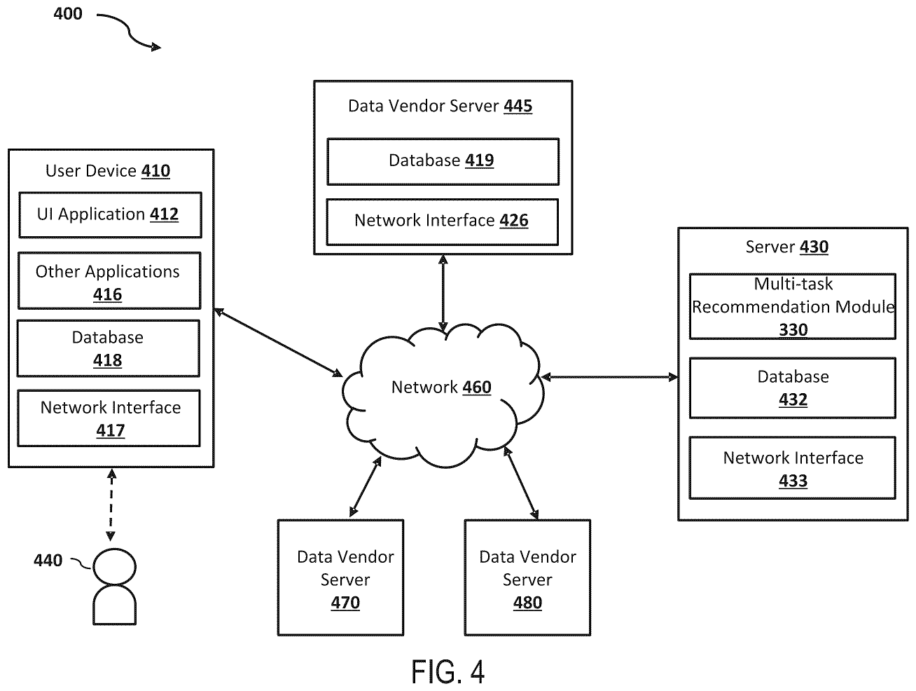

FIG. 4 is a simplified block diagram of a networked system 400 suitable for implementing the personalized multi-task training framework described in FIGS. 2 and 5 and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX®OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating recommended items for purchase from the server 430 and display the message via the UI application 412. In other embodiments, user device 410 may include additional or different modules having specialized hardware and/or software as required.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view recommendations from a recommender system.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including historical interactions between users and items to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the Multi-task recommendation module 330 and its submodules described in FIG. 3A. In some implementations, Multi-task recommendation module 330 may receive data from database 419 at the data vendor server 445 via the network 460 to generate recommendations for a user. The generated recommendations may also be sent to the user device 410 for review by the user 440 via the network 460.

The database 432 may be stored in a transitory and/or non-transitory memory of the server 430. In one implementation, the database 432 may store data obtained from the data vendor server 445. In one implementation, the database 432 may store parameters of the Multi-task recommendation module 330. In one implementation, the database 432 may store previously generated recommendations, and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

### Example Work Flows

FIG. 5A provides an example pseudo-code segment illustrating an example algorithm 500 for a method of optimization based on the framework shown in FIG. 2. FIG. 5B provides an example logic flow diagram illustrating a method of a optimization according to the algorithm 500 in FIG. 5A, according to some embodiments described herein. One or more of the processes of method 550 may be implemented, at least in part, in the form of executable code stored on non-transitory, tangible, machine-readable media that when run by one or more processors may cause the one or more processors to perform one or more of the processes. In some embodiments, method 550 corresponds to an example operation of the Multi-task recommendation module 330 (e.g., FIG. 3A).

As illustrated, the method 550 includes a number of enumerated steps, but aspects of the method 550 may include additional steps before, after, and in between the enumerated steps. In some aspects, one or more of the enumerated steps may be omitted or performed in a different order.

At step 552, time series data indicating a user-item interaction history is received via a data interface (e.g., 315 in FIG. 3).

At step 554, time series data is transformed (e.g., by processor 310 in FIG. 3) into a user-item graph (e.g., 205 in FIG. 2). In some instances, transforming the time series data includes one or more of: creating a first node representing at least one user (e.g., one of the nodes in 210 in FIG. 2) and a second node representing at least one item (e.g., one of the nodes 215 in FIG. 2); adding an edge between the first node and the second node representing that the at least one user has interacted with the at least one item; or associating the edge with a score (e.g., Rᵤᵢ as described herein) representing a preference level/rating score of the at least one user towards the at least one item, as described herein.

At step 556, the user-item graph (e.g., 205) is encoded, by a neural network encoder (e.g., 220 in FIG. 2), into user embeddings (e.g., 222 in FIG. 2) and item embeddings (e.g., 224 in FIG. 2).

At step 558, a plurality of losses (e.g., 230b, 232b, and 234b as depicted in FIG. 2; and as described in Eq. 2) is generated according to a plurality of training tasks (e.g., tasks as depicted in FIG. 1; 230a, 232a, 234a as depicted in FIG. 2) performed based on the user embeddings (e.g., 222 in FIG. 2) and item embeddings (e.g. 224 in FIG. 2). In some instances, one or more losses from the plurality of losses are computed further based on information including any one or more of: user profile information (e.g., 226 in FIG. 2) and user social connection information (e.g., 226 in FIG. 2). In some instances, training tasks may include predicting item(s) for a user, predicting a social connection for a user, or predicting the category for an item (e.g., the three tasks depicted in FIG. 1).

At step 560, recommendation neural network model is trained (e.g., by framework 200 depicted in FIG. 2) by updating the user embeddings and the item embeddings via backpropagation based on a weighted sum of gradients (e.g., as described in Eq. 6) of the plurality of losses. In one embodiment, only user/item embedding tables (e.g., 222, 224 in FIG. 2) are updated when the encoder (e.g., 220 in FIG. 2) does not contain trainable parameters. In one embodiment, the encoder (e.g., 220 in FIG. 2) may be updated together with the personalized user/item embedding tables (e.g., 222, 224 in FIG. 2) through the backpropagation path. In some instances, training the recommendation neural network includes computing the plurality of gradients (e.g., as described by Eq. 3 and depicted in 235 of FIG. 2) corresponding to the plurality of losses and modifying (e.g., according to Eq. 4) a magnitude of at least one gradient in the plurality of task gradients based on a current training epoch number, s. In some instances, training includes generating a plurality of gradient weights (e.g., according to Eq. 5) from magnitudes of the plurality of gradients, including the at least one gradient with the modified magnitude (e.g., as described in Eq. 4); and computing the weighted sum (e.g., as described in Eq. 6) of gradients of the plurality of losses based on the generated plurality of gradient weights.

At step 562, one or more recommended items are generated, by a neural network decoder (e.g., as described with respect to FIGS. 2 and 334 in FIG. 3A), for a given user based on the updated user embeddings and the updated item embeddings.

### Example Results

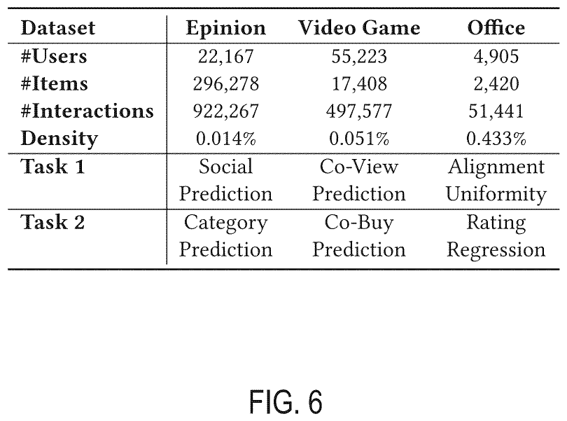

FIGS. 6-11 represent exemplary test results using embodiments described herein. As used in the results section, PMTRec refers to an embodiment of the present disclosure.

Datasets referenced in this disclosure are Epinion as described in Jiliang Tang et al., Exploiting Homophily Effect for Trust Prediction, in the 6th ACM International Conference on Web Search and Data Mining (WSDM 2013); Video Games and Office as described in Ruining He and Julian McAuley, Ups and downs: Modeling the visual evolution of fashion trends with one-class collaborative filtering, in proceedings of the 25th international conference on world wide web. 507-517 (2016).

For Epinion dataset, the Social Prediction task (predict whether two users are social friends) and the Category Prediction task (predict whether two items belong to the same category) are constructed as auxiliary tasks. For Video Game dataset, the co-view and co-buy prediction task to predict whether two items are co-viewed/co-bought together frequently are constructed as auxiliary tasks. For the Office dataset, the Alignment/Uniformity task to directly regularize on the embedding table as well as a rating prediction task to predict the user's explicit rating score towards items are constructed as auxiliary tasks.

Baselines references in this disclosure are EW; GradDrop as described in Zhao Chen, Just pick a sign: Optimizing deep multitask models with gradient sign dropout, in Advances in Neural Information Processing Systems 33, 2039-2050 (2020); PCGrad as described in Tianhe Yu, Gradient surgery for multi-task learning, in Advances in Neural Information Processing Systems 33, 5824-5836 (2020); GradVac as described in Zirui Wang, Gradient vaccine: Investigating and improving multi-task optimization in massively multilingual models, in arXiv preprint, arXiv:2010·05874 (2020); CAGrad as described in Bo Liu, Conflict-averse gradient descent for multi-task learning, in Advances in Neural Information Processing Systems 34, 18878-18890 (2021); Aligned MTL as described in Dmitry Senushkin, Independent Component Alignment for Multi-Task Learning, in Proceedings of the IEEE/CVF Conference on Computer Vision and Pattern Recognition, 20083-20093 (2023); and RLW as described in Baijiong Lin, Reasonable effectiveness of random weighting: A litmus test for multi-task learning, in arXiv preprint arXiv:2111·10603 (2021).

EW (Equal Weight) adds all the losses together with equal weight. GradDrop detects the gradient conflict on each parameter and drops the conflict signal with a probability measured by the gradient scale. PCGrad (Project Conflicting Gradients) changes one of the optimization directions of conflict gradients to make the gradients conflict-free. GradVac (Gradient Vaccine) is an updated version of PCGrad to further align the un-conflict gradients to similar directions. CAGrad (Conflict-Averse Gradient descent) minimizes the average loss function by leveraging the worst local improvement of individual tasks to regularize the trajectory. Aligned MTL uses a condition number of a linear system of gradients as a stability criterion to guide the multi-task learning optimization. RLW (Random Loss Weight) assigns loss weight randomly in each epoch to explore the optimization on different tasks.

In some embodiments, effectiveness is tested on a Top-K recommendation task with K=20, 40, using three widely adopted evaluation metrics: Recall@K (R@K), Hit Ratio@K (HR@K), and Normalized Discounted Cumulative Gain@K (N@K). In some embodiments, user/item embedding size d is fixed to 32 with Xavier initialization, batch size is set to 2048, and use Adam optimizer to optimize parameters. Grid search is used to find optimal setting for remaining hyper parameters. The learning rate is searched in {0.1, 0.05, 0.01, 0.005, 0.001}, coefficient of weight decay is tuned in {1e⁻², 1e⁻⁴, 1e⁻⁶, 1e⁻⁸}. The task focusing base α is search from 1.0 to 1.2 with a step size of 0.02, and the temperature t in {10,1,1e⁻¹, 1e⁻², 1e⁻³, 1e⁻⁴, 1e⁻⁵, 1e⁻⁶}. Training is stopped after 10 successive epochs without improvement.

FIG. 6 is a table depicting the statistics of the datasets.

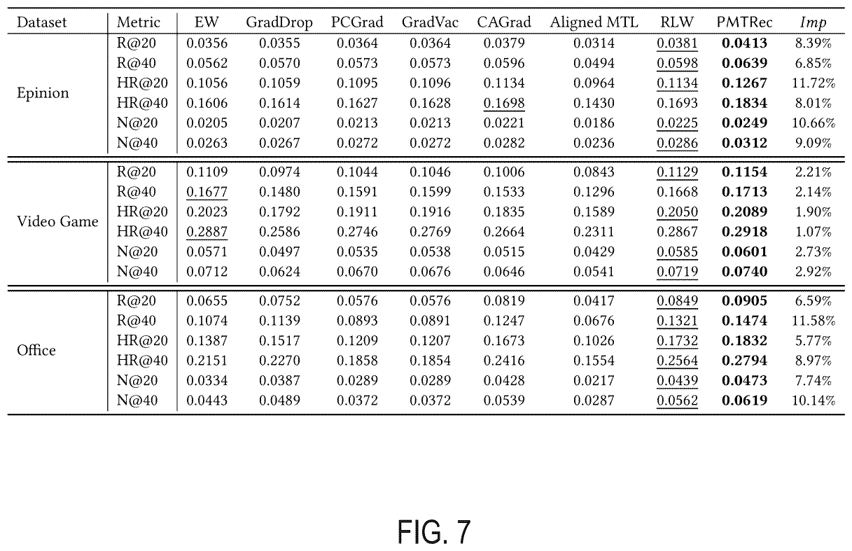

FIG. 7 is a table of the overall comparison in performance. Best performer is in bold, and runner-up is underlined. PMTRec clearly outperforms all other baselines. The percent improvement from runner-up to best is shown in the final column.

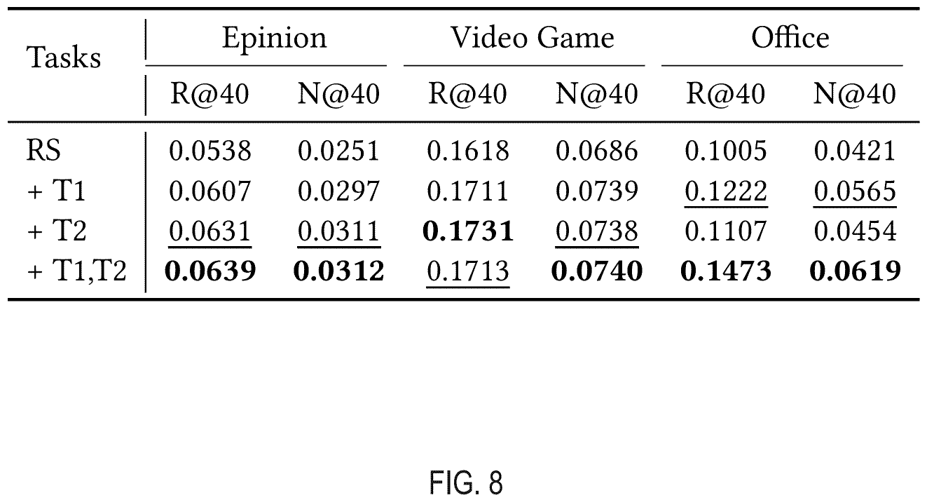

FIG. 8 is an investigation of the impact of including varying numbers of auxiliary tasks with the main recommender task, RS. The inclusion of auxiliary tasks during training improves performance.

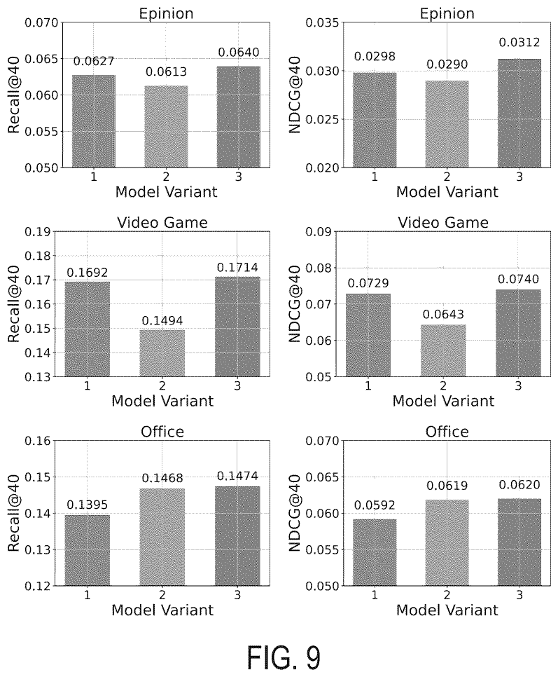

FIG. 9 includes a plurality of plots depicting performance of the framework described herein with and without certain steps in the framework. Variant 1 omits the task focusing. Variant 2 excludes the gradient magnitude balancing, and Variant 3 represents the full framework 200. Variant 3 outperforms all other variants.

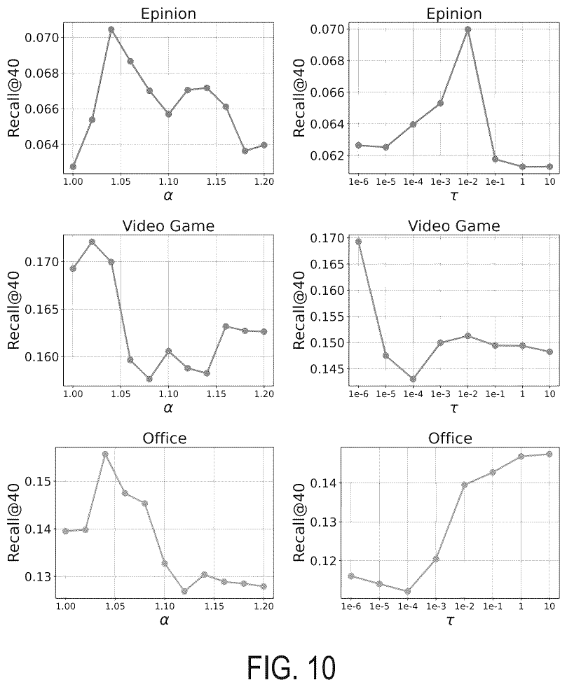

FIG. 10 depicts the sensitivity of performance on hyper-parameter values, α and τ.

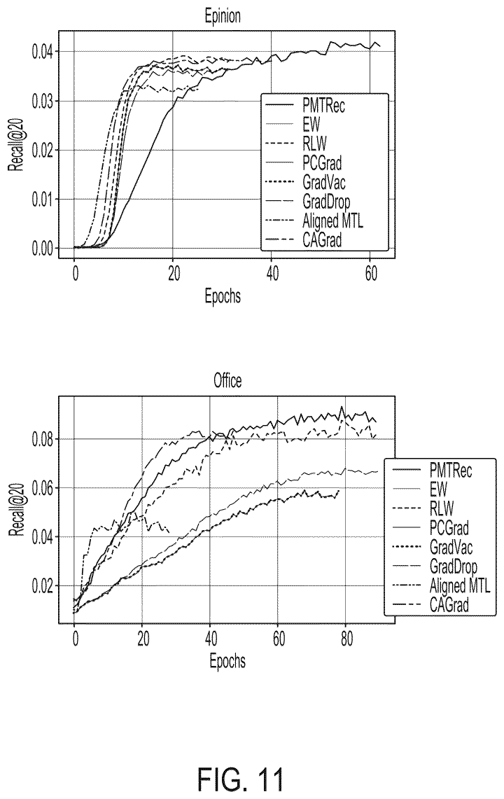

FIG. 11 depicts the training curve of the baselines and PMTRec. On Epinion, performance continues to improve for PMTRec after other baselines have plateaued. On Office, PMTRec outperforms all baselines after plateauing.

In some embodiments, the time complexity of forward/backward propagation on each task is the same and infeasible to measure due to the varied task design. Thus, only the overhead time complexity caused by multi-task training is analyzed. For each user/item, computing the norm of an embedding gradient takes [symbol] (d). The Task focusing will only cost [symbol] (1) as it only computes on the RS task. Then the Gradient Magnitude Balancing takes [symbol] ( [symbol] ). Thus, the overall time complexity is [symbol] ((| [symbol] |+| [symbol] |)×(d+| [symbol] |)) , where [symbol] , [symbol] , and [symbol] are the user/item/task set respectively and d is the embedding dimension. It is noted that the (| [symbol] |+| [symbol] |) dimension can be easily batched up for parallel computation, which makes the wall clock time even much faster. The batched version is shown in FIG. 5A with all the modules marked correspondingly, and ∇_{E} is the aggregated gradient on embedding E obtained from the encoder.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is;:

1. A method for training a recommendation neural network model using multiple data sources, the method comprising:
receiving, via a data interface, time series data indicating a user-item interaction history;
transforming the time series data into a user-item graph;
encoding, by a neural network encoder, the user-item graph into user embeddings and item embeddings;
generating a plurality of losses according to a plurality of training tasks performed based on the user embeddings and, item embeddings;
training the recommendation neural network model by updating the user embeddings and the item embeddings via backpropagation based on a weighted sum of gradients of the plurality of losses; and
generating, by a neural network decoder, one or more recommended items for a given user based on the updated user embeddings and the updated item embeddings.

2. The method of claim 1, wherein the transforming the time series data into a user-item graph comprises:
creating a first node representing at least one user and a second node representing at least one item;
adding an edge between the first node and the second node representing that the at least one user has interacted with the at least one item; and
associating the edge with a score representing a preference level of the at least one user towards the at least one item.

3. The method of claim 1, wherein the plurality of training tasks comprise any one or more of:
a task of predicting an item for a user;
a task of predicting a social connection for a user; and
a task of predicting an item category for a user.

4. The method of claim 1, wherein the training the recommendation neural network model comprises keeping the neural network encoder unchanged during the backpropagation.

5. The method of claim 1, the training the recommendation neural network model comprises:
computing the plurality of gradients corresponding to the plurality of losses; and
modifying a magnitude of at least one gradient in the plurality of task gradients based on a current training epoch number.

6. The method of claim 5, the training the recommendation neural network model comprises:
generating a plurality of gradient weights from magnitudes of the plurality of gradients, including the at least one gradient with the modified magnitude; and
computing the weighted sum of gradients of the plurality of losses based on the generated plurality of gradient weights.

7. The method of claim 1, wherein one or more losses from the plurality of losses are computed further based on information including any one or more of:
user profile information; and
user social connection information.

8. A system for making recommendations, the system comprising:
a memory that stores a recommendation neural network model and a plurality of processor executable instructions;
a communication interface that receives time series data indicating a user-item interaction history; and
one or more hardware processors that read and execute the plurality of processor- executable instructions from the memory to perform operations comprising:
transforming the time series data into a user-item graph;
encoding, by a neural network encoder, the user-item graph into user embeddings and item embeddings;
generating a plurality of losses according to a plurality of training tasks performed based on the user embeddings and, item embeddings;
training the recommendation neural network model by updating the user embeddings and the item embeddings via backpropagation based on a weighted sum of gradients of the plurality of losses; and
generating, by a neural network decoder, one or more recommended items for a given user based on the updated user embeddings and the updated item embeddings.

9. The system of claim 8, the operation of transforming the time series data into a user-item graph further comprising:
creating a first node representing at least one user and a second node representing at least one item;
adding an edge between the first node and the second node representing that the at least one user has interacted with the at least one item; and
associating the edge with a score representing a preference level of the at least one user towards the at least one item.

10. The system of claim 8, wherein the plurality of training tasks comprise any one or more of:
a task of predicting an item for a user;
a task of predicting a social connection for a user; and
a task of predicting an item category for a user.

11. The system of claim 8, the operation of training the recommendation neural network model comprising keeping the neural network encoder unchanged during the backpropagation.

12. The system of claim 8, the operation of training the recommendation neural network comprising:
computing the plurality of gradients corresponding to the plurality of losses; and
modifying a magnitude of at least one gradient in the plurality of task gradients based on a current training epoch number.

13. The system of claim 8, the operating of training the recommendation neural network comprising:
generating a plurality of gradient weights from magnitudes of the plurality of gradients, including the at least one gradient with the modified magnitude; and
computing the weighted sum of gradients of the plurality of losses based on the generated plurality of gradient weights.

14. The system of claim 8, wherein one or more losses from the plurality of losses are computed further based on information including any one or more of:
user profile information; and
user social connection information.

15. A non-transitory machine-readable medium comprising a plurality of machine-executable instructions which, when executed by one or more processors, are adapted to cause the one or more processors to perform operations comprising:
transforming time series data indicating a user-item interaction history into a user- item graph;
encoding, by a neural network encoder, the user-item graph into user embeddings and item embeddings;
generating a plurality of losses according to a plurality of training tasks performed based on the user embeddings and, item embeddings;
training the recommendation neural network model by updating the user embeddings and the item embeddings via backpropagation based on a weighted sum of gradients of the plurality of losses; and
generating, by a neural network decoder, one or more recommended items for a given user based on the updated user embeddings and the updated item embeddings.

16. The non-transitory machine-readable medium of claim 15, wherein transforming the time series data indicating a user-item interaction history into a user-item graph further comprises:
creating a first node representing at least one user and a second node representing at least one item;
adding an edge between the first node and the second node representing that the at least one user has interacted with the at least one item; and
associating the edge with a score representing a preference level of the at least one user towards the at least one item.

17. The non-transitory machine-readable medium of claim 15, wherein the plurality of training tasks comprise any one or more of:
a task of predicting an item for a user;
a task of predicting a social connection for a user; and
a task of predicting an item category for a user.

18. The non-transitory machine-readable medium of claim 15, wherein the training the recommendation neural network model comprises keeping the neural network encoder unchanged during the backpropagation.

19. The non-transitory machine-readable medium of claim 15, the training the recommendation neural network model comprises:
computing the plurality of gradients corresponding to the plurality of losses; and
modifying a magnitude of at least one gradient in the plurality of task gradients based on a current training epoch number.

20. The non-transitory machine-readable medium of claim 19, the training the recommendation neural network model comprises:
generating a plurality of gradient weights from magnitudes of the plurality of gradients, including the at least one gradient with the modified magnitude; and
computing the weighted sum of gradients of the plurality of losses based on the generated plurality of gradient weights.
